(19) United States
(12) Patent Application Publication
(10) Pub. No.: US 2013/0057023 A1
(43) Pub. Date: Mar. 7, 2013

(54) SUNRAY TRACKING SOLAR CELL APPARATUS FOR VEHICLE

(71) Applicants: Won Jung KIM, Seoul (KR); Yong Jun JANG, Gyeonggi-do (KR); Yong Gu KIM, Gyeonggi-do (KR); In Woo SONG, Gyeonggi-do (KR); Mi Yeon SONG, Seoul (KR); Ki Chun LEE, Seoul (KR); Sang Hak KIM, Seoul (KR); Ji Yong LEE, Gyeonggi-do (KR)

(72) Inventors: Won Jung KIM, Seoul (KR); Yong Jun JANG, Gyeonggi-do (KR); Yong Gu KIM, Gyeonggi-do (KR); In Woo SONG, Gyeonggi-do (KR); Mi Yeon SONG, Seoul (KR); Ki Chun LEE, Seoul (KR); Sang Hak KIM, Seoul (KR); Ji Yong LEE, Gyeonggi-do (KR)

(73) Assignee: HYUNDAI MOTOR COMPANY, Seoul (KR)

(21) Appl. No.: 13/288,124

(22) Filed: Nov. 3, 2011

(30) Foreign Application Priority Data
Sep. 5, 2011 (KR) 10-2011-0089862

(51) Int. Cl. B62D 25/00

(52) U.S. Cl. 296/181.1

(57) ABSTRACT

Disclosed is a sunray tracking solar cell apparatus for a vehicle. The apparatus includes a vehicle body panel having a top surface on which a solar cell is mounted, one or more height adjustable actuators that are installed on an undersurface of the vehicle body panel and move upward and downward, and an integrated controller that controls operation of the height adjustable actuators by integrally using signals output from various sensors mounted on the vehicle which are used by the integrated controller to determine the most efficient positioning for the solar cell.

### CROSS-REFERENCE TO RELATED APPLICATION

This application claims under 35 U.S.C. §119(a) the benefit of Korean Patent Application No. 10-2011-0089862 filed Sep. 5, 2011, the entire contents of which are incorporated herein by reference.

### BACKGROUND

(a) Technical Field

The present invention relates to a sunray tracking solar cell apparatus for a vehicle. More particularly, it relates to a sunray tracking solar cell apparatus for a vehicle that can optimize sunray collection by adjusting the tilt of a vehicle body panel, on which a solar cell is mounted, in accordance with an irradiation angle of the sun's rays and a location and position of the vehicle.

(b) Background Art

With a growing global interest on the eco-friendly energy field, much research for applying a photo-electric conversion device such as a solar cell to vehicles has been conducted. Especially, expectation for developing a solar cell for a vehicle has sparked a significant amount of interest. For example, a sunroof on which a silicon solar cell panel is installed has been applied to the top of a vehicle body of a hybrid electric vehicle (HEV).

However, when the solar cell is mounted on a vehicle, the sun ray collection rate varies significantly based on the vehicles current location and position. Therefore, since the sunray collection rate cannot always be optimized, the solar cell for the vehicle has its drawback in that it has a lower electric generating efficiency than is actually possible.

In addition, since the solar cell installed on the vehicle has a limited installable space as compared with the solar cell that is generally installed on an outer wall or roof of a building, it is important to obtain a maximum electric generating efficiency as much as possible in a limited area which takes up as little space as possible.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a sunray tracking solar cell apparatus that is configured to optimize sunray collection by installing an actuator on the vehicle panel, which can ascend and descend a vehicular panel on which a solar cell is mounted, and adjusting the tilt of the vehicle body panel on which the solar cell is mounted by controlling operation of the actuator in based on the vehicle's location and position and irradiation angle of the sun's rays.

In one aspect, the present invention provides a sunray tracking solar cell apparatus for a vehicle, including a vehicle body panel having a top surface on which a solar cell is mounted, one or more height adjustable actuators that are installed on an undersurface of the vehicle body panel and move upward and downward, and an integrated controller that controls operation of the height adjustable actuators by integrally using signals output by the various sensors mounted on the vehicle.

In some exemplary embodiment, the height adjustable actuators may be mounted on respective corners of the undersurface of the vehicle body panel and expand and contract to ascend and descend corners of the vehicle body panel.

In another exemplary embodiment, the height adjustable actuators may be additionally mounted on respective middle-edge portions of the undersurface of the vehicle body panel and expand and contract to ascend and descend their respective edges of the vehicle body panel.

In still another exemplary embodiment, the sensors may be selected from the group consisting of an outdoor temperature sensor, a global positioning system, a magnetic field sensor, and a combination thereof and the integrated controller controls the operation of the height adjustable actuators by using signals output from at least one of the sensors.

According to the exemplary embodiment of the present invention, since the solar cell mounted on the vehicle body panel tracks the sun's rays in accordance with the information signals output from the sensors mounted on the vehicle, the solar panel can optimally collect the sun's rays to maximize the sunray collection rate and thus the electric generating efficiency can be maximized regardless of the irradiation angle of the sun's rays and the position and location of the vehicle.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic view of a solar cell apparatus for a vehicle according to an exemplary embodiment of the present invention;

FIG. 2 is a schematic view of a solar cell apparatus for a vehicle according to another exemplary embodiment of the present invention; and

FIGS. 3 to 6 are views illustrating a variety of operational states of the solar cell apparatus of FIG. 1.

Reference numerals set forth in the Drawings includes reference to the following elements as further discussed below:
10: vehicle surface
11: vehicle body panel on which solar cell is mounted
12: panel support
13: support
14: rack gear
15: electric motor
16: integrated controller
17: sensors mounted on vehicle
18: height adjustable actuator
18a: corner actuators
18b, 18c: middle-edge actuators

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention relates to a solar cell apparatus for a vehicle that can variably change a position of a vehicle body panel on which a solar cell is installed in accordance with an irradiation angle of sun's rays. The vehicle body panel is designed to be tilted in a variety of directions in accordance with the irradiation angle of the sun's rays and a location and position of the vehicle by an integrated controller that performs the control by integrally using signals output from a variety of sensors mounted on the vehicle. Accordingly, the invention is designed to optimize collection of the sun's rays by controlling the tilt of the solar cell installed on the vehicle body panel in accordance with the irradiation angle of the sun's rays and the position and location of the vehicle

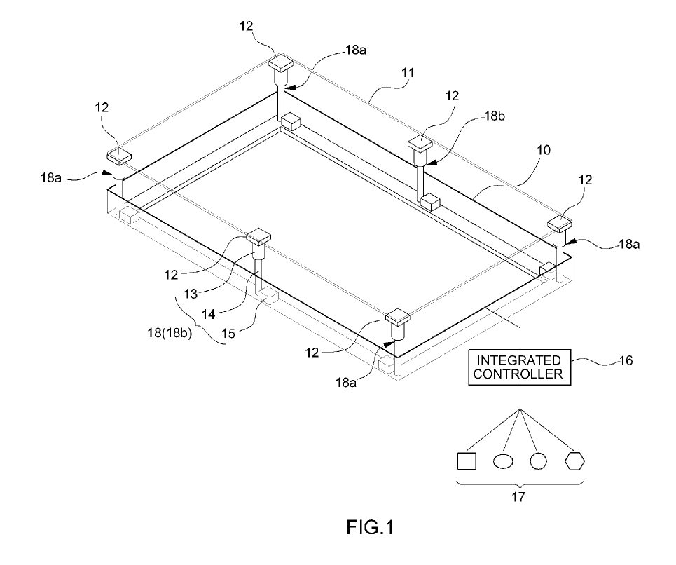

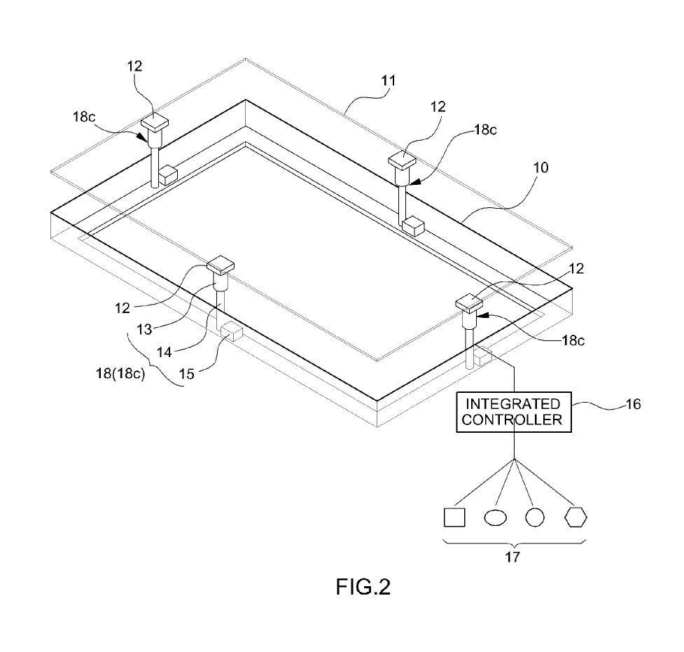

As shown in FIGS. 1 and 2, a solar cell apparatus for a vehicle according to an exemplary embodiment of the present invention may include a vehicle body panel 11 on which a solar cell is mounted, a plurality of height adjustable actuators 18 that are installed on an undersurface of the vehicle body panel 11 and are configured to retract and detract upward and downward according to control performed by an integrated controller 16. Control of the actuators is performed by the integrated controller 16, by integrally using signals output from a variety of sensors 17 mounted on the vehicle. This vehicle panel 11 may be mounted on an outward facing surface a vehicle, for example the vehicles roof.

Angle adjustment of the vehicle body panel 11 on which the solar cell is installed can be effectively realized by the operation of the height adjustable actuators 18. For instant, as shown in FIG. 1, the height adjustable actuators 18 may be classified into corner actuators 18a and middle actuators 18b. The corner actuators 18a may be respectively disposed on corners of the under or bottom surface of the vehicle body panel 11. The corner actuators 18a operate to retract and detract upward and downward, thereby ascending or descending the respective corners of the vehicle body panel 11 depending upon how particular actuators are instructed to move. For example, one actuator 18c may be controlled to move a first specified distance while other actuators may be controlled to move a second specified distance.

Alternatively, in order to provide more stable support for the vehicle body panel 11, the middle actuators 18b may instead be disposed on middle portions of edges (also referred to as “middle-edge portion) of the vehicle body panel 11 between the opposite corners of the vehicle body panel 11.

According to another exemplary embodiment, as shown in FIG. 2, height adjustable actuators 18c may be mounted on middle portions of the edges of the bottom/under surface of the vehicle body panel 11 to retract or detract in the vertical direction, thereby ascending or descending the at least one edge of the vehicle body panel 11 and at least a portion of two other edges of the vehicle panel. For example, the panel may be tilted at an angle in any direction which can be suitable formed by retracting and detracting the actuators in specific combinations.

As shown in FIG. 1, when the corner actuators 18a are disposed on the corners of the vehicle body panel 11, at least one selected corner of the vehicle body panel 11 is ascended or descended by the control of the integrated controller 16. When all of the corners of the vehicle body panel 11 except for one corner are ascended, one of left-front, left-rear, right-front, and right-rear portions of the vehicle body panel 11 is lifted.

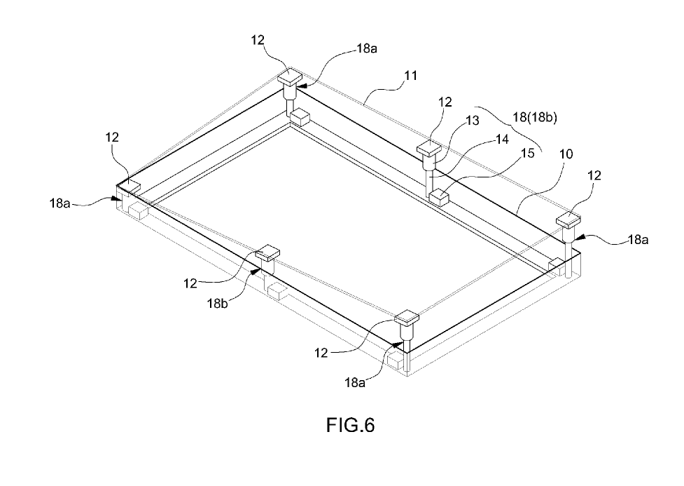

Referring to FIG. 6, when all of the corners of the vehicle body panel 11 except for the left-front corner are ascended, the vehicle body panel 11 is lifted at the right-rear portion. At this point, the expanding length of the right-rear actuator 18a is at its highest point and the left-rear and right-front actuators 18a and the middle (middle-edge) actuators 18b are retracted/expanded by to lengths that are suitable in accordance with required tilt of the vehicle body panel 11. That is, as one of the corners of the vehicle body panel 11 is lifted, the actuators 18 expand in response to the tilt of the vehicle body panel 11 and support the vehicle body panel 11 accordingly.

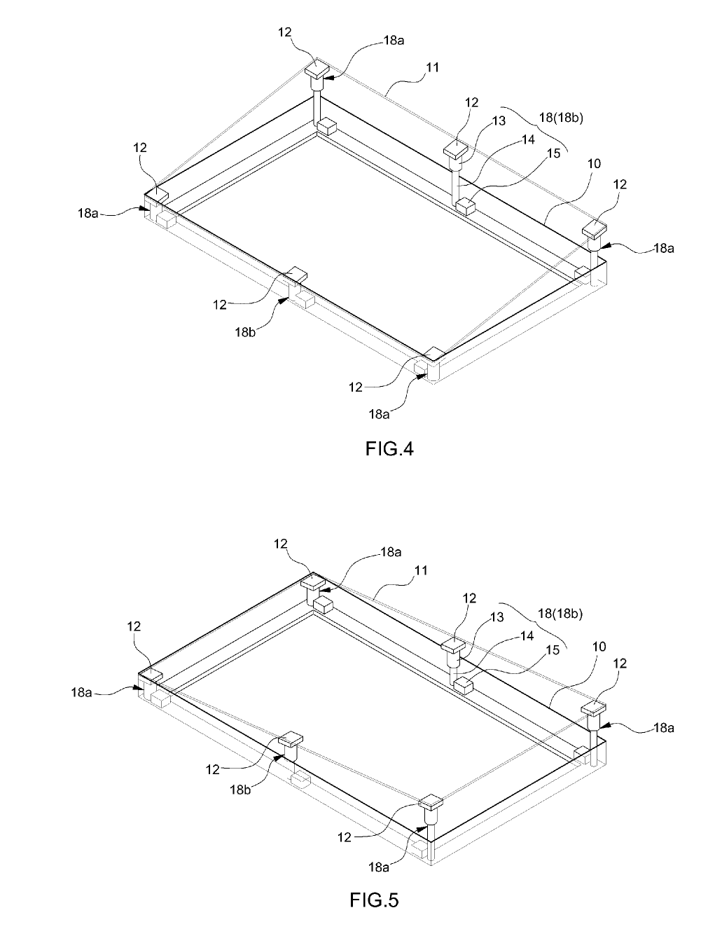

In addition, as the actuators 18 that are arranged in a straight line expand, the rear or right portion of the vehicle body panel 11 may be lifted as shown in FIGS. 4 and 5. The vehicle body panel 11 may be lifted in an opposite aspect to the above. That is, one of front, rear, left, and right sides of the vehicle body panel 11 may be ascended or returned to the initial position in accordance with an irradiation angle of the sun's rays (or location of the sun).

The above-described operation of the actuators 18 are controlled by the integrated controller 16. That is, the expansion and contraction or the retraction and detraction lengths of the actuators 18 installed on the under/bottom surface of the vehicle body panel 11 are determined by the integrated controller 16 that integrally controls the operation of the respective actuators 18 through the use of information input from the variety of different sensors 17 mounted on the vehicle. By the determined expanding and contraction lengths, the tilt of the vehicle body panel 11 can be controlled.

As described above, the vehicle body panel 11 on which the solar cell is mounted can be freely lifted at the front, rear, left, right, and diagonal portions thereof by the height adjustable actuators 18. Therefore, the position (or tilt) of the vehicle body panel 11 can be adjusted in response to the location of the sun, thereby maximizing the sunray collection efficiency in accordance with the location and position of the vehicle and the irradiation angle of the sun's rays.

Referring to FIGS. 1 and 2, panel supports 12 are mounted on the respective corner portions and middle-edge portions of the under/bottom surface of the vehicle body panel 11 and the height adjustable actuators 18 are mounted between the respective panel supports 12 and a vehicle surface 10. Any apparatuses that can expand and contract or retract and detract in the vertical direction to move the respective supports 13 upward and downward and thus ascend and descend the vehicle body panel 11 may be used as the height adjustable actuators 18. In addition, components for constituting a conventional actuator may be used.

For example, referring to FIGS. 1 and 2, the height adjustable actuator 18 may include an electric motor 15 mounted on the vehicle surface or substrate 10, a pinion (not shown) connected to a driving shaft of the electric motor 15, a rack gear 14 having a first end engaged with the pinion and a second end coupled to the support and configured to move up and down along a guide of the support 13 and the support in which the second end of the rack gear is inserted and which is coupled to an undersurface of the panel support 12. Here, the guide is formed on an inner wall of the support 13 to function to guide the up-and-down movement of the rack gear 14. In addition, the height adjustable actuator 18 may use any one of a hydraulic cylinder, a pneumatic cylinder, an electric cylinder, a mechanical cylinder, and a combination thereof. Further, various gears such as worm gears, bevel gears, and the like may be used as gear components.

Additionally, an outdoor temperature sensor, a global positioning system (GPS), a magnetic field sensor, a tilt sensor, and the like may be used as the sensors 17 that provide information for the integrated controller to control the operation of the height adjustable actuator 18. Other sensors that can be mounted on the vehicle may be also used. The integrated controller 16 controls the operation of the actuators 18 based on signals received from at least one of the sensors.

The outdoor temperature sensor is for detecting an outdoor temperature of the vehicle. By using the outdoor temperature sensor, the intensity of the current sun's rays can be noted. The GPS is for identifying a current location of the vehicle. By using the GPS, an absolute time of the vehicle can be obtained, whereby information on the current location of the vehicle and solar attitude can be identified.

The magnetic field sensor is for detecting a moving direction of the vehicle by detecting a direction of a weak magnetic field flowing in the earth. By using the magnetic field sensor, the moving direction of the vehicle can be determined The tilt sensor is for detecting a current position of the vehicle based on whether the vehicle is tilting frontward, rearward, leftward, or rightward. By using the tilt sensor, a degree of current tilt of the vehicle can be identified.

The integrated controller 16 may be configured to optimize the tilt of the solar cell mounted on the vehicle body panel 11 in accordance with the irradiation angle of the sun's rays and the position and location of the vehicle by integrally using the information obtained from the sensors 17. Among the above-described sensors 17, at least one or more sensors may be used. However, in order to effectively track the sun's rays, the control by the integrated controller 16 may be realized by providing various sensor signals to the integrated controller 16. That is, by using various sensors rather than using one sensor, the information on the outdoor temperature, the information on the position (or tilt) and location of the vehicle, the information on the moving direction of the vehicle, and the information on the solar attitude may be integrated and thus the solar cell mounted on the vehicle body panel 11 may be optimally moved in accordance with the location of the sun.

As described above, the optimal location and position of the vehicle body panel 11 with respect to the irradiation angle of the sun's rays may be determined by integrating the information on the current intensity of the sun's rays, the information on the solar attitude, and the information on the location and tilt of the vehicle, which can be obtained from the information signals output from the sensors 17 such as the outdoor temperature sensor, GPS, magnetic field sensor, and tilt sensor, and the like. That is, based on the information, the integrated controller 16 controls the operation of the respective actuators 18 such that the vehicle body panel 11 has the optimal location and position.

In addition, the control of the tilt position of the vehicle body panel 11 by the height adjustable actuators 18 can be variously realized. This will be described hereinafter.

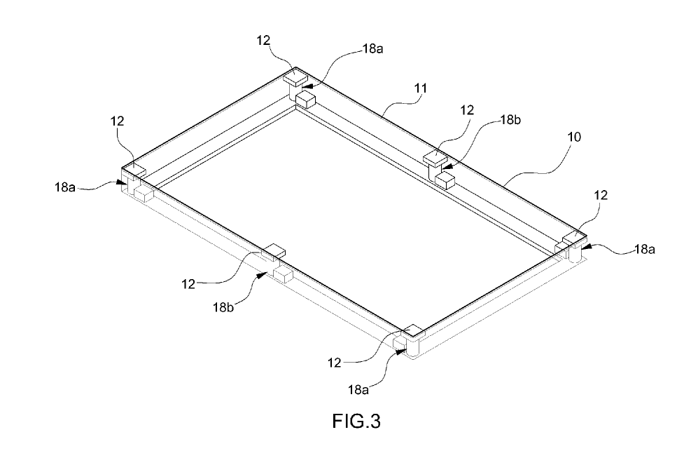

FIGS. 3 to 6 are views that exemplarily illustrate the operational state of the exemplary embodiment of FIG. 1. FIG. 3 illustrates a state where the vehicle body panel 11 is contracted closely to the vehicle surface 10 before all of the actuators 18 are operated. In this state, all of the actuators 18 are contracted (detracted). Accordingly, an opening of the vehicle surface 10 is in a closed state.

FIG. 4 illustrates a state where the vehicle body panel 11 is tilted like a common sunroof. Accordingly, the vehicle body panel 11 is tilted frontward (i.e., the front portion of the vehicle body panel 11 closely contacts the vehicle surface 10) and thus the rear portion of the vehicle body panel 11 is lifted. In contrast, it may be also possible that the vehicle body to panel 11 is tilted rearward (i.e., the rear portion of the vehicle body panel 11 closely contacts the vehicle surface 10) and thus the front portion of the vehicle body panel 11 is lifted.

FIG. 5 is similar to FIG. 4. However, FIG. 5 illustrates a state where the vehicle body panel 11 is tilted leftward. That is, the left portion of the vehicle body panel 11 contacts close to the vehicle surface 10 and the right portion of the vehicle body panel 11 is lifted.

As described above, FIG. 6 illustrates a state where all of the portions of the vehicle body panel 11 except for the left-front portion are lifted. That is, the left-front portion of the vehicle body panel 11 closely contacts the vehicle surface 10 and the rest of the panel is lifted by the actuators 18. In addition, it is also possible that the vehicle body panel 11 may be tilted left-rearward, right-frontward, or right-rearward and thus the rest of the actuator and panel portions except for one of the left-rear, right-front, and right-rear portions are lifted.

As described above, since the vehicle body panel 11 can be variably freely tilted in accordance with the location of the sun, the electric generating efficiency of the solar cell having the limited area and mounted on the vehicle body panel 11 can be maximized Meanwhile, as a part of the vehicle body, the vehicle body panel 11 can open and close exposing the vehicle surface 10 by moving upward and downward in accordance with the operation of the height adjustable actuators 18.

As shown in FIG. 1, the vehicle body panel 11 may be tilted leftward, rightward, frontward, rearward, and in a diagonal direction by the actuators 18 installed on the corners of the vehicle body panel 11. In addition, when the vehicle body panel 11 is designed to have an area similar to or same as a whole area of the roof the vehicle, the actuators 18 may be installed on only middle portions of the edges of the vehicle body panel 11 as shown in FIG. 2 such that the vehicle body to panel 11 can be tilted only frontward, rearward, leftward, and rightward considering the running performance of the vehicle.

In addition, when the vehicle body panel 11 supporting the solar cell continuously moves while the vehicle is driving or stopping, the electric power consumption and motive power consumption are increased. Therefore, it may be possible to control the vehicle body panel 11 such that the vehicle body panel 11 changes its tilt at a predetermined time (e.g., changes its tile every ten minutes), thereby reducing the electric power consumption and motive power consumption of the vehicle and preventing the vehicle body panel from obstructing the performance of the vehicle.

In addition, in order to naturally maintain the airflow passing over and through the vehicle body panel 11 when the running performance of the vehicle is deteriorated by the tilt adjustment of the vehicle body panel 11, for example, when the front portion of the vehicle body panel 11 is lifted, like the conventional panorama sunroof, wind shielding visors may be installed on the front edge or all of the edges of the vehicle body panel 11.

The solar cell apparatus for the vehicle according to the exemplary embodiment of the present invention may be generally applied to a roof panel of the vehicle, which has the largest area in the outer surface of the vehicle. However, the present invention is not limited to this. The solar cell apparatus may be applied to any portions on which the solar cell can be mountable, such as a hood panel, a trunk panel, a fender panel, and the like.

The solar cell apparatus for the vehicle according to the exemplary embodiment of the present invention may be applied to various vehicles such as automobiles, bikes, bicycles, and the like by mounting the solar cell, actuators, and proper sensors on the vehicles. In addition, the solar cell apparatus may be also applied to buildings by installing the solar cell, actuators, and proper sensors on the buildings.

In the drawings, the dimensions of the components may be exaggerated for clarity of the solar cell apparatus for the vehicle of the present invention. In addition, the vehicle body panel may be curved depending on the vehicle's design. For convenience, a flat vehicle body panel is however illustrated in the drawing, not limiting the present invention.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A sunray tracking solar cell apparatus for a vehicle comprising:
a vehicle body panel having a top surface on which a solar cell is mounted;
one or more height adjustable actuators that are installed on an undersurface of the vehicle body panel and move upward and downward; and
an integrated controller configured to control the operation of the height adjustable actuators based on signals output from various sensors mounted on the vehicle which are used by the integrated controller to determine the most efficient positioning for the solar cell.

2. The sunray tracking solar cell apparatus of claim 1, wherein the height adjustable actuators are mounted on respective corners of the undersurface of the vehicle body panel and retract and detract to ascend and descend corners of the vehicle body panel.

3. The sunray tracking solar cell apparatus of claim 1, wherein the height adjustable actuators are mounted on respective middle-edge portions of the undersurface of the vehicle body panel and retract and detract to ascend and descend edges of the vehicle body panel.

4. The sunray tracking solar cell apparatus of claim 1, wherein the sensors are selected from the group consisting of an outdoor temperature sensor, a global positioning system, a magnetic field sensor, and a combination thereof and the integrated controller controls the operation of the height adjustable actuators by using signals output from at least one of the sensors.

5. The sunray tracking solar cell apparatus of claim 1, wherein the height adjustable actuators are each independently controlled based on the desired tilt direction of the solar cell.
